(19) United States
(12) Patent Application Publication
(10) Pub. No.: US 2026/0036451 A1
(43) Pub. Date: Feb. 5, 2026

(54) Attachment Device And Physical Quantity Detection Device

(71) Applicant: SEIKO EPSON CORPORATION, Tokyo (JP)

(72) Inventors: Masayuki OTO, Okaya (JP); Jun WATANABE, Matsumoto (JP)

(21) Appl. No.: 19/283,719

(22) Filed: Jul. 29, 2025

(30) Foreign Application Priority Data
Jul. 30, 2024 (JP) 2024-123221

(51) Int. Cl. G01D 11/30

(52) U.S. Cl. CPC G01D 11/30

(57) ABSTRACT

An attachment device is a device for attaching a physical quantity sensor to a measurement target. The attachment device includes a base on which the physical quantity sensor is mounted, a magnet having an attraction surface attracted to the measurement target, and an attraction yoke having attraction ends attracted to the measurement target by the magnetic force of the magnet. The attraction yoke is a yoke that is displaced relatively to the magnet in a first direction (a z direction) along a normal line of the attraction surface to attract at least a part of the attraction surface of the magnet and the attraction ends of the attraction yoke to the measurement target.

The present application is based on, and claims priority from JP Application Serial Number 2024-123221, filed Jul. 30, 2024, the disclosure of which is hereby incorporated by reference herein in its entirety.

### BACKGROUND

### 1. Technical Field

The present disclosure relates to an attachment device, a physical quantity detection device, and the like.

### 2. Related Art

JP-A-2013-195173 discloses a technique in which, in an attachment device including a sensor holder including a first dual leg section and a yoke including a second dual leg section, an acceleration sensor is fixed to a magnet via the yoke and the distal end portion of the first dual leg section comes into contact with a target object.

JP-A-2013-195173 is an example of the related art.

In JP-A-2013-195173, the acceleration sensor is fixed to the target object by the magnetic attraction force of the magnet. However, there is a problem in that the distance between the magnet and the target object changes depending on the shape of the target object and it is difficult to improve the magnetic attraction force for measurement targets having various shapes.

### SUMMARY

An aspect of the present disclosure relates to an attachment device for attaching a physical quantity sensor to a measurement target, the attachment device including: a base on which the physical quantity sensor is mounted; a magnet having an attraction surface that is attracted to the measurement target; and an attraction yoke having an attraction end that is attracted to the measurement target by a magnetic force of the magnet, wherein the attraction yoke is a yoke that is displaced relatively to the magnet in a first direction along a normal line of the attraction surface to attract at least a part of the attraction surface of the magnet and the attraction end of the attraction yoke to the measurement target.

Another aspect of the present disclosure relates to a physical quantity detection device including: the attachment device explained above; and the physical quantity sensor.

### BRIEF DESCRIPTION OF THE DRAWINGS

FIG. 1 is a schematic cross-sectional view of a physical quantity detection device.

FIG. 2 is a diagram of an attachment device viewed from a rear surface side.

FIG. 3 is an A-A cross-sectional view of the attachment device.

FIG. 4 is a perspective view in a state in which the attachment device is attached to a measurement target.

FIG. 5 is a cross-sectional view of cross sections of the attachment device and the measurement target parallel to a yz plane.

FIG. 6 is a cross-sectional view of an attachment device attached to a flat measurement target in a cross section parallel to the yz plane.

FIG. 7 is a diagram illustrating fixing of an attraction yoke and a magnet.

### DESCRIPTION OF EMBODIMENTS

A preferred embodiment of the present disclosure is explained in detail below. Note that the present embodiment explained below does not unduly limit the content described in the claims and not all of the components explained in the present embodiment are always essential elements.

### 1. Configuration Example

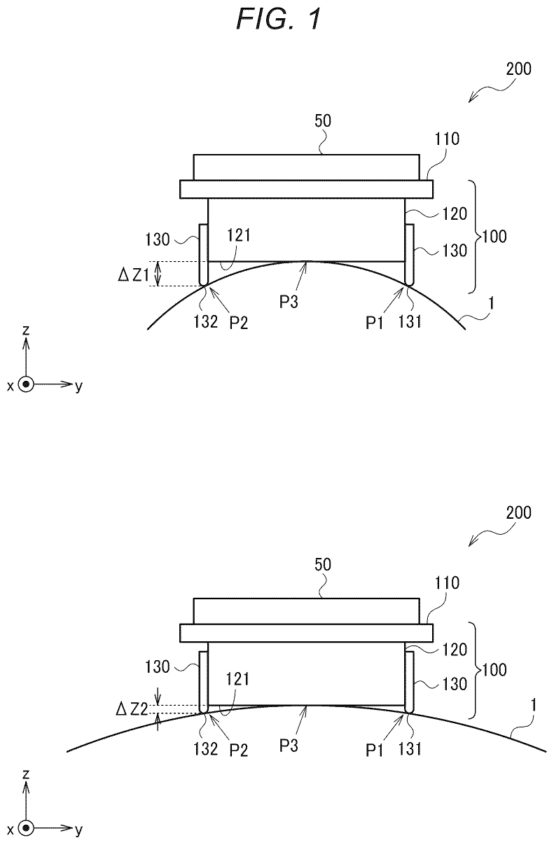

FIG. 1 is a cross-sectional view illustrating an overview of a physical quantity detection device 200. The physical quantity detection device 200 includes a physical quantity sensor 50 and an attachment device 100. FIG. 1 illustrates a state in which the physical quantity detection device 200 is attached to a measurement target 1. However, the physical quantity detection device 200 is detachably attachable to the measurement target 1.

The measurement target 1 includes, for example, a vibration source that generates vibration with mechanical operation. The physical quantity sensor 50 detects vibration of the measurement target 1 generated by the vibration source. The vibration source is, for example, a motor, an engine, or a turbine. The measurement target 1 may not include a vibration source, vibration may be applied from the outside of the measurement target 1, and the physical quantity sensor 50 may detect the vibration. The measurement target 1 is, for example, the vibration source itself, that is, the motor, the engine, the turbine, or the like. Alternatively, the measurement target 1 is a machine, equipment, a device, or the like including a vibration source and is, for example, home equipment or industrial equipment such as a printer, an air conditioner, a robot, a pump, a belt conveyor, or machining equipment, a vehicle such as an automobile or an airplane, or industrial equipment such as a generator or a manufacturing plant. Alternatively, the measurement target 1 may be a structure that vibrates with an external force, such as a building, a road, or a bridge.

In FIG. 1, three orthogonal directions are defined as an x direction, a y direction, and a z direction. A direction pointed by an arrow is sometimes referred to as +x direction and a direction opposite to the direction is sometimes referred to as −x direction. FIG. 1 illustrates a cross-sectional view in a cross section parallel to a yz plane. As an example of the measurement target 1, a cylindrical object having a central axis parallel to the x direction is illustrated. For example, a bearing of a rotary machine such as a motor is assumed. However, the shape of the measurement target 1 is not limited thereto and only has to be a shape of the measurement target 1 that can stably support the physical quantity sensor 50 with respect to the measurement target 1 with the mechanism of the attachment device 100 in the present embodiment explained later. As an example of the non-cylindrical shape, the measurement target 1 may be, for example, an uneven shape having regular or irregular intervals in the cross-section of the yz plane. In this case, it is obvious that, by attaching the attachment device 100 such that a convex portion of the measurement target 1 is located near the center of the attachment device 100, the attachment device 100 can be stably attached similarly to attachment to a cylinder explained below.

The physical quantity sensor 50 is a sensor that detects a physical quantity transmitted from the measurement target 1 via the attachment device 100. In a specific example, the physical quantity sensor 50 detects acceleration, velocity, displacement, angular acceleration, angular velocity, or an angle and outputs a signal indicating the detected physical quantity. These physical quantities can also be considered information for representing the vibration of the measurement target 1. The physical quantity sensor 50 can also be referred to as vibration sensor. The physical quantity sensor 50 may be a sensor that detects one type of physical quantity or may be a sensor that detects a plurality of types of physical quantities. The physical quantity sensor 50 may be a sensor that detects a physical quantity of one axis or a sensor that detects physical quantities of two or more axes.

As an example, the physical quantity sensor 50 is an acceleration sensor or a gyro sensor using a quartz crystal unit as a detection element or an acceleration sensor or a gyro sensor using an MEMS as a detection element. The physical quantity sensor 50 may be an inertial measurement unit (IMU) formed as a unit by combining an acceleration sensor and a gyro sensor. The physical quantity sensor 50 may detect the speed or the displacement by integrating the acceleration detected by the detection element or may use a detection element that detects speed or the like. The physical quantity sensor 50 may detect angular acceleration or an angle by differentiating or integrating the angular velocity detected by the detection element or may use a detection element that detects angular acceleration or the like. An example of the acceleration sensor is a sensor that detects acceleration by making use of the fact that a vibration frequency changes according to stress applied to the quartz crystal unit and measuring the vibration frequency. An example of the gyro sensor is a sensor that detects angular velocity by detecting a Coriolis force applied to the quartz crystal unit. Another example of the acceleration sensor or the gyro sensor is a sensor in which a mass portion and electrodes are configured by MEMS, the sensor detecting acceleration or angular velocity by detecting the capacitance between the electrodes that changes according to an inertial force applied to the mass portion.

The attachment device 100 is a device for attaching the physical quantity sensor 50 to the measurement target 1. In a specific example, the measurement target 1 such as the motor explained above includes a ferromagnetic body in at least a part of the surface thereof. The attachment device 100 is attached to the ferromagnetic body on the surface of the measurement target 1 by being attracted by a magnetic force. The ferromagnetic body may be covered with an exterior of plastic or the like or may be coated with paint or the like. The attachment device 100 includes a base 110, a magnet 120, and an attraction yoke 130.

The base 110 is a plate-shaped member, the thickness direction of which is the z direction, and is made of a hard material such as metal or resin. The physical quantity sensor 50 is mounted on the surface on a +z-direction side of the base 110. The base 110 and the physical quantity sensor 50 are detachably fixed by a screw, an adhesive, an adhesive tape, or the like. The magnet 120 is fixed to the surface on a-z-direction side of the base 110. The base 110 and the magnet 120 are fixed by a screw, an adhesive, an adhesive tape, or the like. “Fixing” of two objects A and B means that the objects A and B are fixed such that a positional relationship between the objects A and B does not relatively move and is not limited to a case in which the objects A and B are fixed in direct contact with each other. For example, the base 110 and the magnet 120 may be fixed in a state in which a fixed yoke explained below is present between the base 110 and the magnet 120, that is, in a state in which the base 110 and the magnet 120 are not in direct contact with each other.

The magnet 120 has an attraction surface 121 attracted to the measurement target 1 by a magnetic force. The attraction surface 121 means a surface on the side opposite to a surface fixed to the base 110, that is, a surface on the −z-direction side of the magnet 120. The attraction surface 121 is assumed to be a flat surface but may be a curved surface that is convex or concave in a-z direction. On the attraction surface 121, basically, a magnet itself is exposed. However, a part of the attraction surface 121 may be formed as a non-magnet member such as a screw or a hole or the surface of the attraction surface 121 may be coated with thin resin or the like. The magnet 120 has, for example, a rectangular parallelepiped shape or a plate shape and has, for example, a rectangular shape or a square shape when viewed in the z direction. The magnet 120 is, for example, a neodymium magnet, an alnico magnet, or a ferrite magnet. The direction of the magnetic pole may be optional. As an example, one of the S pole and the N pole may be present on the attraction surface 121 and the other of the S pole and the N pole may be present on the surface on the opposite side.

“Yoke” of the attraction yoke 130 reinforces the attraction force of the magnet 120 by collecting magnetic fluxes of the magnet 120 in the yoke. The attraction yoke 130 has a frame shape surrounding the side surfaces of the magnet 120 and is a ferromagnetic body magnetized by the magnetic force of the magnet 120. The side surfaces of the magnet 120 mean four surfaces on the +x-direction side, the −x-direction side, a +y-direction side, and a −y-direction side of the magnet 120. Since FIG. 1 is a cross-sectional view, only the surfaces on the +y-direction side and the −y-direction side are illustrated. The attraction yoke 130 has the same rectangular or square shape as the outer shape of the magnet 120 when viewed in the z direction and is provided to surround the immediate outer side of the magnet 120. That is, the side surfaces of the magnet 120 and the inner side surfaces of the attraction yoke 130 are in contact. The attraction yoke 130 is not fixed to the magnet 120 and can be displaced in a +z direction or the −z direction along the side surfaces of the magnet 120. The +z direction or the −z direction can also be referred to as direction along the normal line of the attraction surface 121. This direction is set as a first direction. At this time, it can be said that the attraction yoke 130 is displaced in the first direction relatively to the magnet 120.

The attraction yoke 130 has the four surfaces on the +x-direction side, the −x-direction side, the +y-direction side, and the −y-direction side as explained above. A first attraction end 131 is provided on the surface on the +y-direction side and a second attraction end 132 is provided on the surface on the −y-direction side. The first attraction end 131 and the second attraction end 132 are sometimes collectively referred to as attraction ends 131 and 132. The attraction ends 131 and 132 are end portions on the −z-direction side on two surfaces on the +y-direction side and the −y-direction side, that is, end portions that are in contact with the measurement target 1. When viewed in the z direction, the attraction ends 131 and 132 are provided on two sides parallel to the central axis of a cylinder, which is the measurement target 1, that is, two sides in the x direction among the four sides of the attraction yoke 130 having the rectangular shape or the square shape. These linear attraction ends 131 and 132 of the two sides are in contact with the measurement target 1.

As illustrated in an upper diagram of FIG. 1, a part of the attraction surface 121 is attracted to the measurement target 1 at a position P3 of the attraction surface 121. When the attraction ends 131 and 132 of the attraction yoke 130 are displaced to protrude in the −z direction from the attraction surface 121, the first attraction end 131 comes into contact with the measurement target 1 at a position P1 and the second attraction end 132 comes into contact with the measurement target 1 at a position P2. A distance of the attraction ends 131 and 132 protruding from the attraction surface 121 at this time is represented as ΔZ1. A lower diagram of FIG. 1 illustrates a case in which the radius of the cylinder, which is the measurement target 1, is larger than the radius in the upper diagram, that is, a case in which the curved surface of the cylinder is gentle. In this case, a protrusion distance ΔZ2 of the attraction ends 131 and 132 in the lower diagram is smaller compared with the protrusion distance ΔZ1 of the attraction end 131 in the upper diagram. The attachment device 100 is attracted to the measurement target 1 at the positions P1 to P3 as explained above.

As explained above, the attachment device 100 in the present embodiment is a device for attaching the physical quantity sensor 50 to the measurement target 1. The attachment device 100 includes the base 110 on which the physical quantity sensor 50 is mounted, the magnet 120 having the attraction surface 121 attracted to the measurement target 1, and the attraction yoke 130 having the attraction ends 131 and 132 attracted to the measurement target 1 by the magnetic force of the magnet 120. The attraction yoke 130 is a yoke that is displaced relatively to the magnet 120 in the first direction (the +z direction or the −z direction) along the normal line of the attraction surface 121 to attract at least a part of the attraction surface 121 of the magnet 120 and the attraction ends 131 and 132 of the attraction yoke 130 to the measurement target 1.

According to the present embodiment, the attraction yoke 130 is freely displaced in the first direction (the +z direction or the −z direction), whereby the attraction yoke 130 is always attracted to the measurement target 1 at the positions P1 and P2 regardless of the radius of the cylinder and the attraction surface 121 of the magnet 120 is attracted to the measurement target 1 at the position P3. Accordingly, the attachment device 100 is stably fixed to the measurement target 1. Since the magnet 120 is in contact with the measurement target 1 at least at the position P3, the distance between the magnet 120 and the measurement target 1 does not increase.

In a specific example, when the distance between the magnet 120 and the measurement target 1 increases, a magnetic field (a magnetic flux density) decreases in inverse proportion to the square of the distance between the magnet 120 and the measurement target 1, and the attraction force of the magnet 120 decreases. For example, as the diameter of the motor increases, in general, an output of the motor increases and vibration increases. In FIG. 1, if the attraction yoke 130 does not move up and down, the distance between the magnet 120 and the measurement target 1 increases as the diameter of the motor is larger, and the attachment device 100 is easily detached from the measurement target 1 or the position of the attachment device 100 is easily moved by vibration. In this regard, according to the present embodiment, since the attraction yoke 130 moves, the attachment device 100 can be attached to the measurement target 1 in a state in which the magnet 120 and the measurement target 1 are always in contact. Accordingly, it is possible to always keep a strong magnetic force and fix the attachment device 100 to the measurement target 1 with a strong attraction force.

In the present embodiment, the magnet 120 may be fixed to the base 110. That is, the attraction yoke 130 may be provided to be displaceable in the +z direction or the −z direction relatively to the base 110 without being fixed to the base 110. Note that not only this but the attraction yoke 130 may be fixed to the base 110. That is, the magnet 120 may be provided to be displaceable in the +z direction or the −z direction relatively to the base 110 without being fixed to the base 110. For example, a recess of the same type as the magnet 120 is provided on the surface on the −z-direction side of the base 110. When the magnet 120 is displaced to the +z-direction side, an upper part of the magnet 120 is fit in the recess of the base 110, whereby the attraction surface 121 of the magnet 120 is displaced further to the +z-direction side than the attraction ends 131 and 132 of the attraction yoke 130. In this way, the protrusion distance of the attraction ends 131 and 132 from the attraction surface 121 freely changes according to the curved surface of the cylinder, which is the measurement target 1.

### 2. Detailed Configuration Examples

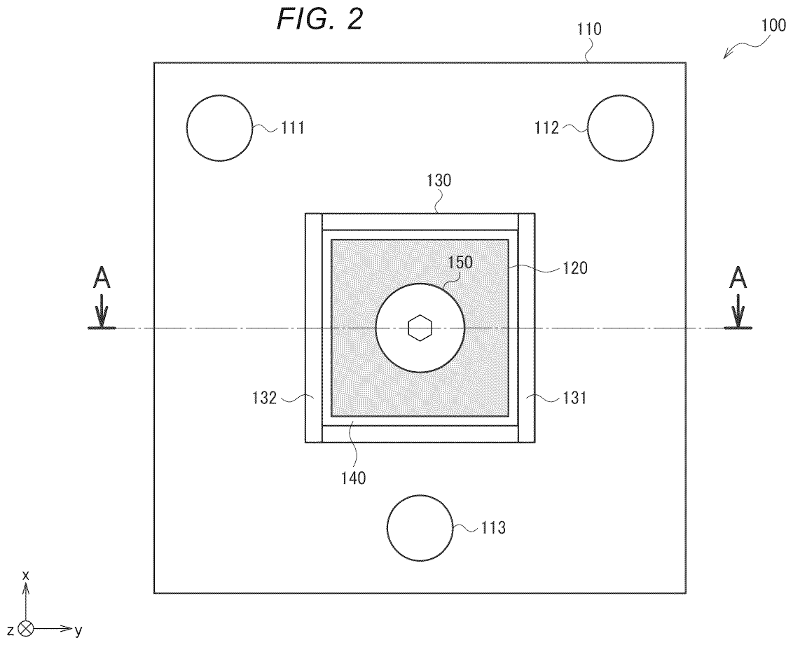

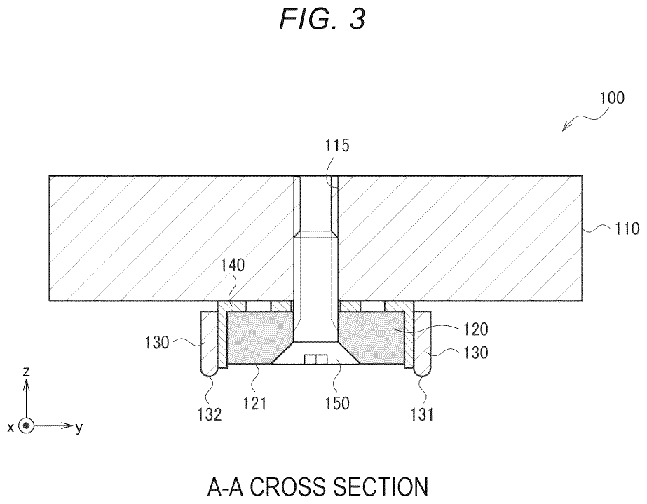

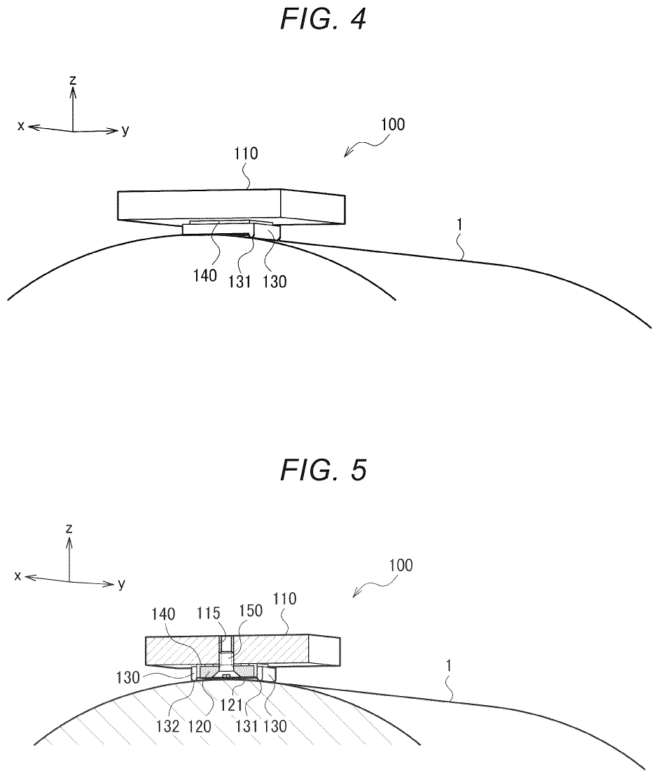

FIGS. 2 to 5 illustrate a detailed configuration example serving as an example of the attachment device 100 explained with reference to FIG. 1. Here, the physical quantity sensor 50 is not illustrated. FIG. 2 is a diagram of the attachment device 100 viewed from the rear surface side, that is, the −z-direction side. FIG. 3 is an A-A cross-sectional view of the attachment device 100 illustrated in FIG. 2. An A-A cross section is a cross section parallel to the yz plane. FIG. 4 is a perspective view in a state in which the attachment device 100 illustrated in FIGS. 2 and 3 is attached to the measurement target 1. FIG. 5 is a cross-sectional view of a cross section parallel to the yz plane of the attachment device 100 and the measurement target 1 illustrated in FIG. 4. In the following explanation, the +z direction is also referred to as upper and the −z direction is also referred to as lower. The width of a member in the z direction is also referred to as height. A surface on the −z-direction side is also referred to as rear surface and a surface on the +z-direction side is also referred to as front surface. Surfaces on the +x-direction side, the −x-direction side, the +y-direction side, and the −y-direction side are also referred to as side surfaces.

The attachment device 100 includes the base 110, the magnet 120, the attraction yoke 130, a fixed yoke 140, and a screw 150. Here, an example in which the magnet 120 is fixed to the base 110 is explained. However, the attraction yoke 130 may be fixed to the base 110 as explained above.

The base 110 has a plate shape or a rectangular parallelepiped shape. The upper surface and the lower surface of the base 110 are parallel to an xy plane. A side surface on the +x-direction side and a side surface on the −x-direction side of the base 110 are parallel to the yz plane. A side surface on the +y-direction side and a side surface on the −y-direction side of the base 110 are parallel to an xz plane. The thickness in the z direction of the base 110 is smaller than the width in the x direction and the width in the y direction. The width in the x direction and the width in the y direction of the base 110 may be the same or may be different. When viewed in the z direction, a screw hole 115 for fixing the magnet 120 is provided at the center of the base 110. When viewed in the z direction, screw holes 111 to 113 for fixing the physical quantity sensor 50 are provided in three parts of the base 110. For example, the screw holes 111 and 112 are provided at both ends of one of two sides facing each other of the base 110 and the screw hole 113 is provided near the center of the other side. The base 110 and the physical quantity sensor 50 are fixed by inserting screws through the screw holes 111 to 113 from below to above the screw holes 111 to 113 and screwing the physical quantity sensor 50. The number and the positions of the screw holes are not limited to the above.

The magnet 120 has a plate shape or a rectangular parallelepiped shape. The upper surface and the lower surface of the magnet 120 are parallel to the xy plane. A side surface on the +x-direction side and a side surface on the −x-direction side of the magnet 120 are parallel to the yz plane. A side surface on the +y-direction side and a side surface on the −y-direction side of the magnet 120 are parallel to the xz plane. The thickness in the z direction of the magnet 120 is smaller than the width in the x direction and the width in the y direction. The width in the x direction and the width in the y direction of the magnet 120 may be the same or may be different. The screw hole 115 is provided at the center of the magnet 120 when viewed in the z direction. The base 110 and the magnet 120 are fixed by inserting the screw 150 through the screw hole 115 of the base 110 from below a screw hole of the magnet 120 and screwing the magnet 120 to the base 110.

As explained with reference to FIG. 1, the attraction yoke 130 may be fixed to the base 110 and the magnet 120 may be movable up and down. In this case, the positions of the magnet 120 and the base 110 relatively move in the z direction by tightening or loosening the screw 150. That is, the up-down movement of the magnet 120 can be adjusted by tightening or loosening the screw 150.

The fixed yoke 140 is fixed to the magnet 120 and is provided to cover the upper surface and the side surfaces of the magnet 120. The lower end in the z direction of the fixed yoke 140 and the position of the attraction surface 121 of the magnet 120 are the same. The fixed yoke 140 is a ferromagnetic body magnetized by the magnetic force of the magnet 120. The fixed yoke 140 includes an upper plate that is in contact with the surface on the +z-direction side of the magnet 120, a first lateral plate that is in contact with the side surface on the +x-direction side of the magnet 120, a second lateral plate that is in contact with the side surface on the −x-direction side of the magnet 120, a third lateral plate that is in contact with the side surface on the +y-direction side of the magnet 120, and a fourth lateral plate that is in contact with the side surface on the −y-direction side of the magnet 120. The upper plate is parallel to the xy plane. The first lateral plate and the second lateral plate are parallel to the yz plane. The third lateral plate and the fourth lateral plate are parallel to the xz plane. A hole for inserting the screw 150 is provided in the upper plate. These five plates may be integrally configured as the fixed yoke 140 without being separated or the fixed yoke 140 may be configured by combining the separated five plates. Besides the hole for inserting the screw 150, holes may be provided in the plates. For example, FIGS. 3 and 5 illustrate an example in which two holes are provided in the upper plate. These holes are holes for pushing out and taking out the magnet 120 from the fixed yoke 140.

The attraction yoke 130 includes a first frame plate that is in contact with the first lateral plate of the fixed yoke 140, a second frame plate that is in contact with the second lateral plate of the fixed yoke 140, a third frame plate that is in contact with the third lateral plate of the fixed yoke 140, and a fourth frame plate that is in contact with the fourth lateral plate of the fixed yoke 140. The first frame plate and the second frame plate are parallel to the yz plane. The third frame plate and the fourth frame plate are parallel to the xz plane. These four plates may be integrally configured as the attraction yoke 130 without being separated or the attraction yoke 130 may be configured by combining the separated four plates. The ends on the +z-direction side of the first to fourth frame plates are at the same position in the z direction, in other words, are present in the same xy plane. The first attraction end 131 is an end portion on the −z-direction side of the third frame plate on the +y-direction side and the second attraction end 132 is an end portion on the −z-direction side of the fourth frame plate on the −y-direction side. The height of the third frame plate and the fourth frame plate having the attraction ends 131 and 132 is larger than the height of the first frame plate on the +x-direction side and the second frame plate on the −x-direction side. That is, the attraction ends 131 and 132 protrude further to the −z-direction side than the end portions on the −z-direction side of the first frame plate and the second frame plate. As illustrated in the perspective view of FIG. 4, since the attraction ends 131 and 132 protrude, when the attraction ends 131 and 132 are attracted to the measurement target 1, the end portions of the first frame plate and the second frame plate do not interfere with the measurement target 1 and the attraction surface 121 of the magnet 120 can be attracted to the measurement target 1.

The attraction ends 131 and 132 of the attraction yoke 130 are curved surfaces that are convex in the −z direction. Specifically, as illustrated in FIG. 3, in the cross section parallel to the yz plane, the attraction ends 131 and 132 are semicircles that are convex in the −z direction. If the attraction ends 131 and 132 have a rectangular shape, a corner on the inner side of the attraction end 131 is always in contact with the cylindrical measurement target 1. At this time, an angle formed by the ends of the attraction ends 131 and 132 and the cylinder changes according to the radius of the cylinder. For this reason, the attraction force of the attraction yoke 130 is likely to change. In this regard, according to the present embodiment, as it is seen when FIG. 1 and the like are viewed, regardless of whether the curved surface of the measurement target 1 is steep or gentle, any one point of the semicircles of the attraction ends 131 and 132 is in contact with the measurement target 1. At this time, since the attraction end 131 and the cylinder of the measurement target 1 are in contact at the tangent line of a circle, a relationship between the attraction end 131 and an angle formed by the measurement target 1 is always constant. Accordingly, the attraction force of the attraction yoke 130 can be made constant regardless of the shape of the measurement target 1.

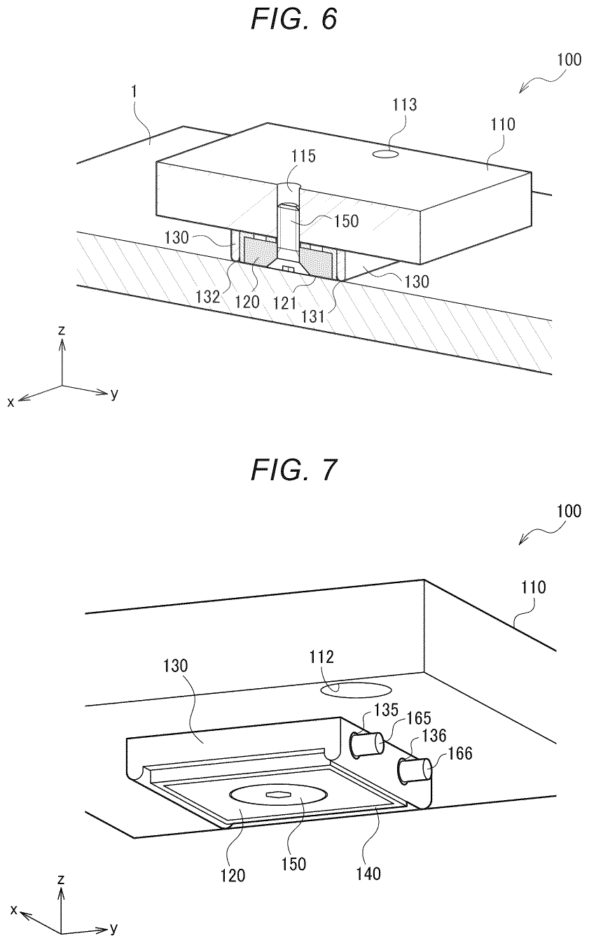

FIG. 6 is a cross-sectional view of the attachment device 100 attached to the flat measurement target 1 in a cross section parallel to the yz plane. When the attachment device 100 is attached to the flat measurement target 1, the attraction ends 131 and 132 of the attraction yoke 130 are attracted to the measurement target 1 and the entire attraction surface 121 of the magnet 120 is attracted to the measurement target 1. That is, the attachment device 100 can be attached not only to the measurement target 1 having a curved surface such as a cylinder but also to a flat portion.

As explained above, the attraction yoke 130 includes the first to fourth frame plates, and the third frame plate and the fourth frame plate have the attraction ends 131 and 132. The height of the third frame plate and the fourth frame plate is equal to or smaller than the height from the attraction surface 121 of the magnet 120 to the upper surface of the upper plate of the fixed yoke 140. Accordingly, when the attraction ends 131 and 132 are attracted to the flat measurement target 1, the attraction surface 121 of the magnet 120 and the attraction ends 131 and 132 have the same height and the attraction surface 121 and the attraction ends 131 and 132 are attracted to the flat measurement target 1.

FIG. 7 is a diagram illustrating fixing of the attraction yoke 130 and the magnet 120. Hereinafter, a case in which the magnet 120 is fixed to the base 110 is explained as an example. However, the present method is also applicable to a case in which the attraction yoke 130 is fixed to the base 110.

Screw holes 135 and 136 are provided in the attraction yoke 130. FIG. 7 illustrates an example in which the screw holes 135 and 136 are provided in the third frame plate on the +y-direction side. The screw holes 135 and 136 are through holes, screws are cut on the inner sides of the screw holes 135 and 136, and screws 165 and 166 can be inserted into the screw holes 135 and 136 in the y direction. When the screws 165 and 166 are turned in a tightening direction, the tips of the screws 165 and 166 come into contact with a side surface of the fixed yoke 140. When the screws 165 and 166 are further turned in the tightening direction, the tips of the screws 165 and 166 push the side surface of the fixed yoke 140 in the −y direction, a force in the +y direction acts on the attraction yoke 130, the fourth frame plate on the −y-direction side of the attraction yoke 130 is pressed against the side surface of the fixed yoke 140, and the attraction yoke 130 is fixed to the magnet 120.

When the attachment device 100 is attached to the measurement target 1, first, the attachment is performed with the screws 165 and 166 loosened. At this time, the attraction yoke 130 moves in the −z direction and the attraction ends 131 and 132 are attracted to the measurement target 1. By tightening the screws 165 and 166 in that state, the attraction yoke 130 and the magnet 120 are fixed as explained above and the stable attachment state explained with reference to FIG. 1 and the like is maintained.

In the present embodiment explained above, the attachment device 100 may include the fixed yoke 140 provided between the magnet 120 and the attraction yoke 130.

Since the attraction yoke 130 moves in the z direction relatively to the magnet 120, the attraction yoke 130 has the frame shape and does not cover the upper surface of the magnet 120. Since the attachment device 100 includes the fixed yoke 140 provided between the magnet 120 and the attraction yoke 130, the upper surface and the side surfaces of the magnet 120 are covered with the yoke. Therefore, the attraction force of the magnet 120 can be reinforced. As explained with reference to FIG. 6 and the like, the length in the first direction (the height in the z direction) of the attraction yoke 130 may be equal to or smaller than the length in the first direction (the height in the z direction) of the fixed yoke 140.

According to the present embodiment, when the upper end of the attraction yoke 130 comes into contact with the base 110, the positions of the attraction ends 131 and 132 in the z direction are the same as or above the lower end of the fixed yoke 140. Accordingly, even when the attachment device 100 is attached not only to the measurement target 1 having the curved surface illustrated in FIG. 4 and the like but also to the flat measurement target 1 illustrated in FIG. 6, the attraction surface 121 of the magnet 120 and the attraction ends 131 and 132 of the attraction yoke 130 can be attracted to the measurement target 1. As explained above, the attachment device 100 in the present embodiment can be attached to the measurement target 1 having various shapes.

In the present embodiment, the fixed yoke 140 may be provided to cover surfaces excluding the attraction surface 121 among the surfaces of the magnet 120.

According to the present embodiment, since the fixed yoke 140 collects magnetic fluxes in the fixed yoke 140 on the surfaces excluding the attraction surface 121 among the surfaces of the magnet 120, the attraction force of the magnet 120 can be reinforced.

In the present embodiment, the attraction yoke 130 may be displaced by sliding on the outer side surface (the side surface) of the fixed yoke 140.

According to the present embodiment, since the attraction yoke 130 slides on the outer side surface (the side surface) of the fixed yoke 140, the attraction yoke 130 can be displaced relatively to the magnet 120 in the first direction (the z direction).

In the present embodiment, the attraction yoke 130 may be attracted to the fixed yoke 140 by a magnetic force.

According to the present embodiment, the fixed yoke 140 is magnetized by the magnetic force of the magnet 120 and the attraction yoke 130 is magnetized by the magnetic forces of the magnet 120 and the fixed yoke 140. Accordingly, a magnetic attraction force due to the magnetic forces acts between the fixed yoke 140 and the attraction yoke 130. After the attraction yoke 130 moves such that the attraction ends 131 and 132 are attracted to the measurement target 1, the position of the attraction yoke 130 is fixed or prevented from easily moving by the attraction forces of the fixed yoke 140 and the attraction yoke 130.

In the embodiment, present a direction orthogonal to the first direction (the z direction) may be set as a second direction (the +y direction) and a direction opposite to the second direction (the +y direction) may be set as a third direction (the −y direction). At this time, the attraction yoke 130 may have, as attraction ends, the first attraction end 131 provided in the second direction (the +y direction) the magnet 120 and the second attraction end 132 provided in the third direction (the −y direction) of the magnet 120.

According to the present embodiment, when the attraction surface 121 of the magnet 120 and the first attraction end 131 and the second attraction end 132 of the attraction yoke 130 are attracted to the measurement target 1, the attachment device 100 is attracted to the measurement target 1 at three points. Accordingly, the attachment device 100 can be stably attracted to the measurement target 1.

In the present embodiment, a direction orthogonal to the first direction (the z direction) and the second direction (the +y direction) may be set as a fourth direction (the x direction). At this time, the first attraction end 131 and the second attraction end 132 may be attraction ends along the fourth direction (the x direction).

According to the present embodiment, the attachment device 100 is attached to the measurement target 1 such that the first attraction end 131 and the second attraction end 132 along the fourth direction are parallel to the central axis of the cylindrical measurement target 1. Accordingly, the entirety of the first attraction end 131 and the second attraction end 132 along the fourth direction comes into contact with the cylindrical side surface and the attachment device 100 is stably attracted to the measurement target 1.

In the present embodiment, the first attraction end 131 and the second attraction end 132 may have a curved surface facing the measurement target 1 in a cross section orthogonal to the fourth direction (the x direction) (a cross section parallel to the yz plane). Specifically, as explained above, the first attraction end 131 and the second attraction end 132 have curved surfaces that are convex in the −z direction.

According to the present embodiment, as it is seen when FIG. 1 and the like are viewed, any one point of the semicircles of the attraction ends 131 and 132 comes into contact with the measurement target 1 regardless of whether the curved surface of the measurement target 1 is steep or gentle. At this time, regardless of the shape of the measurement target 1, a relationship between the attraction end 131 and an angle formed by the measurement target 1 is constant. Therefore, the attraction force of the attraction yoke 130 can be made constant.

As explained with reference to FIG. 7, the attachment device 100 may include fixing members (the screws 165 and 166) that fix the attraction yoke 130, which is displaced relatively to the magnet 120 in the first direction (the z direction), to the magnet 120 at any position.

According to the present embodiment, the attachment device 100 can be attached to the measurement target 1 in a state in which the magnet 120 and the attraction yoke 130 are not relatively fixed by the fixing members and the magnet 120 and the attraction yoke 130 can be relatively fixed by the fixing members after the attachment. Accordingly, after the attraction yoke 130 moves in the −z direction at the time of attachment and the attraction ends 131 and 132 are attracted to the measurement target 1, the position of the attraction yoke 130 can be fixed in that state.

Although the present embodiment is explained in detail as explained above, those skilled in the art could easily understand that many modifications can be made without substantially departing from the novel matters and the effects of the present disclosure. Therefore, all such modifications are deemed to be included in the scope of the present disclosure. For example, a term described at least once together with a different term having a broader meaning or the same meaning in the specification or the drawings can be replaced with the different term in any place in the specification or the drawings. All combinations of the present embodiment and the modifications are also included in the scope of the present disclosure. The configurations, the operations, and the like of the physical quantity detection device, the physical quantity sensor, the attachment device, the base, the magnet, the attraction yoke, the fixed yoke, and the like are not limited to those explained in the present embodiment, and various modifications can be made.

What is claimed is:

1. An attachment device for attaching a physical quantity sensor to a measurement target, the attachment device comprising:
a base on which the physical quantity sensor is mounted;
a magnet having an attraction surface that is attracted to the measurement target; and
an attraction yoke having an attraction end that is attracted to the measurement target by a magnetic force of the magnet, wherein
the attraction yoke is a yoke that is displaced relatively to the magnet in a first direction along a normal line of the attraction surface to attract at least a part of the attraction surface of the magnet and the attraction end of the attraction yoke to the measurement target.

2. The attachment device according to claim 1, further comprising a fixed yoke provided between the magnet and the attraction yoke.

3. The attachment device according to claim 2, wherein length in the first direction of the attraction yoke is equal to or smaller than length in the first direction of the fixed yoke.

4. The attachment device according to claim 2, wherein the fixed yoke is provided to cover surfaces excluding the attraction surface among surfaces of the magnet.

5. The attachment device according to claim 2, wherein the attraction yoke is displaced by sliding on an outer side surface of the fixed yoke.

6. The attachment device according to claim 2, wherein the attraction yoke is attracted to the fixed yoke by a magnetic force.

7. The attachment device according to claim 1, wherein
when a direction orthogonal to the first direction is set as a second direction and a direction opposite to the second direction is set as a third direction,
the attraction yoke has, as the attraction end, a first attraction end provided in the second direction of the magnet and a second attraction end provided in the third direction of the magnet.

8. The attachment device according to claim 7, wherein
when a direction orthogonal to the first direction and the second direction is set as a fourth direction,
the first attraction end and the second attraction end are attraction ends in the fourth direction.

9. The attachment device according to claim 8, wherein the first attraction end and the second attraction end have curved surfaces facing the measurement target in a cross section orthogonal to the fourth direction.

10. The attachment device according to claim 1, wherein the magnet is fixed to the base.

11. The attachment device according to claim 1, wherein the attraction yoke is fixed to the base.

12. The attachment device according to claim 1, further comprising a fixing member that fixes the attraction yoke, which is displaced relatively to the magnet in the first direction, to the magnet at any position.

13. A physical quantity detection device comprising:
the attachment device according to claim 1; and
the physical quantity sensor.
